(19) United States
(12) Patent Application Publication
(10) Pub. No.: US 2005/0165690 A1
(43) Pub. Date: Jul. 28, 2005

(54) Watermarking via quantization of rational statistics of regions

(75) Inventors: Tie Liu, Urbana, IL (US); M. Kivanc Mihcak, Redmond, WA (US); Ramarathnam Venkatesan, Redmond, W (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/764,345

(22) Filed: Jan. 23, 2004

(51) Int. Cl. G06F 17/60

(52) U.S. Cl. 705/57

(57) ABSTRACT

Described herein is a technology for facilitating watermarking of digital goods. The technology, described herein, performs watermark embedding and the detection of embedded watermarks based upon rational statistics of multiple regions of a digital good

### TECHNICAL FIELD

This invention generally relates to a technology for facilitating watermarking of digital goods.

### BACKGROUND

Digital images, audio, video, software, and the like are examples of digital goods. Unfortunately, it is relatively easy for a person to pirate the pristine digital content of a digital good at the expense and harm of the content owners—which includes the content author, publisher, developer, distributor, etc. The Therefore, the content-based industries (e.g., entertainment, music, film, software, etc.) that produce and distribute content are plagued by lost revenues due to digital piracy.

“Digital goods” is a generic label, used herein, for electronically stored or transmitted content. Examples of digital goods include images, audio clips, video, multimedia, software, and data. Depending upon the context, digital goods may also be called a “digital signal,” “content signal,” “digital bitstream,” “media signal,” “digital object,” “object,” “signal,” and the like.

Watermarking

Watermarking is one of the most promising techniques for protecting the content owner's rights of a digital good. Generally, watermarking is a process of slightly altering the digital good to embed a detectable “mark,” but doing so in a manner that preserves the perceptual characteristics of the content. Generally, watermarks are designed to be invisible or, more precisely, to be imperceptible to humans and statistical analysis tools.

A watermark embedder (i.e., encoder) is used to embed a watermark into a digital good. A watermark detector is used to detect, extract, or verify the presence (or absence) of the watermark in a digital good that may be watermarked.

Conventional Watermarking Technology

Conventional technologies for watermarking media signals rely on the imperfections of human perceptions (e.g., the human auditory system (HAS) or the human visual system (HVS)). For example, in the realm of audio signals, several conventional secret hiding techniques explore the fact that the HAS is insensitive to small amplitude changes—either in the time or frequency domains—as well as insertion of low-amplitude time-domain echoes.

The watermark can be regarded as an additive signal w, which contains the encoded and modulated watermark message b under constraints on the introduced perceptible distortions given by a mask M so that:
x=s+w(M).

Commonly-used, conventional watermark embedding techniques can be classified into spread-spectrum (SS) (which is often implemented using additive or multiplicative techniques) and quantization-based watermarking schemes.

Those of ordinary skill in the art are familiar with conventional techniques and technology associated with watermarks, watermark embedding, and watermark detecting.

### SUMMARY

Described herein is a technology for facilitating watermarking of digital goods. The technology, described herein, performs watermark embedding and the detection of possibly embedded watermarks based upon rational statistics of multiple regions of a digital good.

### BRIEF DESCRIPTION OF THE DRAWINGS

The same numbers are used throughout the drawings to reference like elements and features.

FIG. 1 is a schematic block diagram showing a watermarking architecture in accordance with an implementation described herein.

FIG. 2 is a schematic block diagram showing an embodiment (e.g., a watermark embedding system) described herein.

FIG. 3 shows an image with examples of regions employed by an implementation that is restrictively non-overlapping.

FIG. 4 shows an image with examples of regions employed by an implementation, in accordance with at least one described herein, that is permissively overlapping.

FIG. 5 is a schematic block diagram showing an embodiment (e.g., a watermark detecting system) described herein.

FIG. 6 is a flow diagram showing an illustrative methodological implementation described herein.

FIG. 7 is an example of a computing operating environment capable of (wholly or partially) implementing at least one embodiment described herein.

### DETAILED DESCRIPTION

The following description sets forth techniques for embedding and detecting watermarks in digital goods by quantizing robust, semi-global, rational statistics of content regions found in such digital goods. The techniques may be implemented in many ways, including on computing systems or computer networks, as part of a digital goods production and distribution architecture, or in applications and cryptosystems.

An exemplary implementation of these techniques may be referred to as an “exemplary watermarker” and is described below.

Exemplary Watermarking Architecture

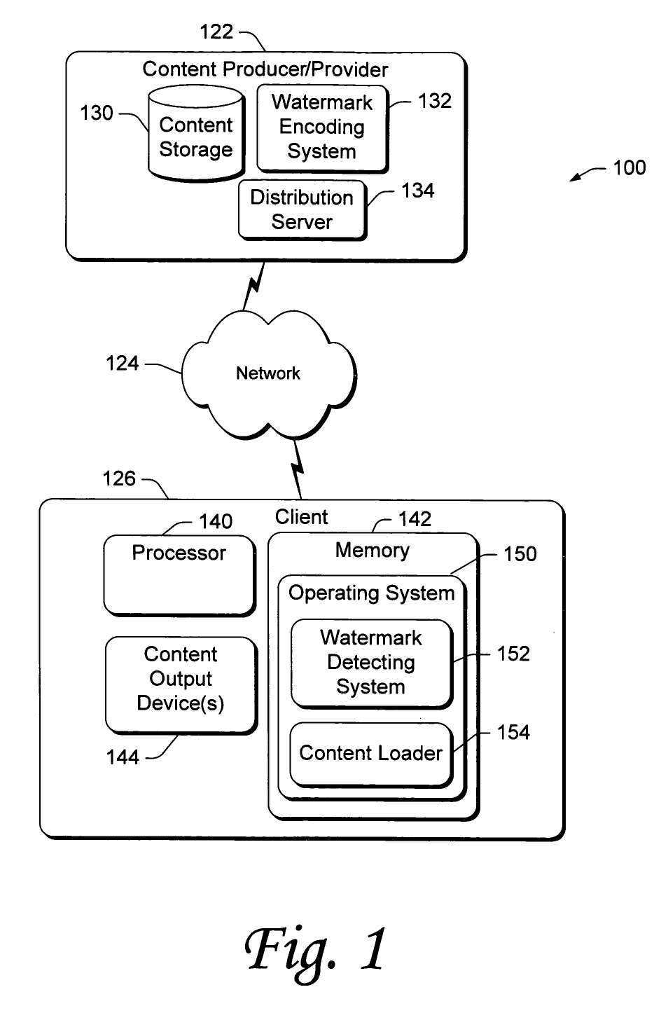

FIG. 1 shows exemplary watermarker having a content producer/provider 122 that produces original content, which it distributes over a network 124 to a client 126. The content producer/provider 122 has a content storage 130 to store digital goods containing original content. The content producer 122 has a watermark encoding system 132 to sign the digital goods (e.g., audio, video, image, or other digital signals) with a watermark that uniquely identifies the content as original. The watermark embedding system 132 may be implemented as a standalone process or incorporated into other applications or operating systems.

In general, the watermark encoding system 132 derives robust, semi-global, rational statistics of a digital good's content regions. It then embeds the watermark by quantizing such rational statistics.

The watermark encoding system 132 retrieves the watermark from the content storage 130. This watermark may identify the content producer 122, and provide a signature that is embedded in the signal and cannot be cleanly removed.

The content producer/provider 122 has a distribution server 134 that distributes the watermarked content over the network 124 (e.g., the Internet). The server 134 may further compress and/or encrypt the content with conventional compression and encryption techniques prior to distributing the content over the network 124. Furthermore, the server 134 may also apply several DRM techniques to increase the security of the system before distributing the content over the network 124.

Typically, the client 126 is equipped with a processor 140, a memory 142, and one or more content output devices 144 (e.g., display, sound card, speakers, etc.). To process the marked goods, the processor 140 may run various tools which decompress the signal, decrypt the date, filter the content, and/or apply signal controls (tone, volume, etc.). The memory 142 stores an operating system 150, which executes on the processor. The client 126 may be embodied in many different ways, including as a computer, a handheld entertainment device, a set-top box, a television, an appliance, and so forth.

The operating system 150 implements a client-side watermark detecting system 152 to detect watermarks in the received digital good (if there are any) and a content loader 154 (e.g., multimedia player, audio player) to facilitate the use of content through the content output device(s) 144. If the watermark is present, the client can identify its associated information, such as copyright and licensing information.

The operating system 150 and/or processor 140 may be configured to enforce certain rules imposed by the content producer/provider (or copyright owner). For instance, the operating system and/or processor may be configured to reject fake or copied content that does not possess a valid watermark. In another example, the system could load unverified content with a reduced level of fidelity. In yet another example, the watermark may correspond to the identities of customers and thus it may be used to trace to the origins of owner of the content; this may be useful for forensics applications.

Exemplary Semi-Global Quantization Watermark Embedding System

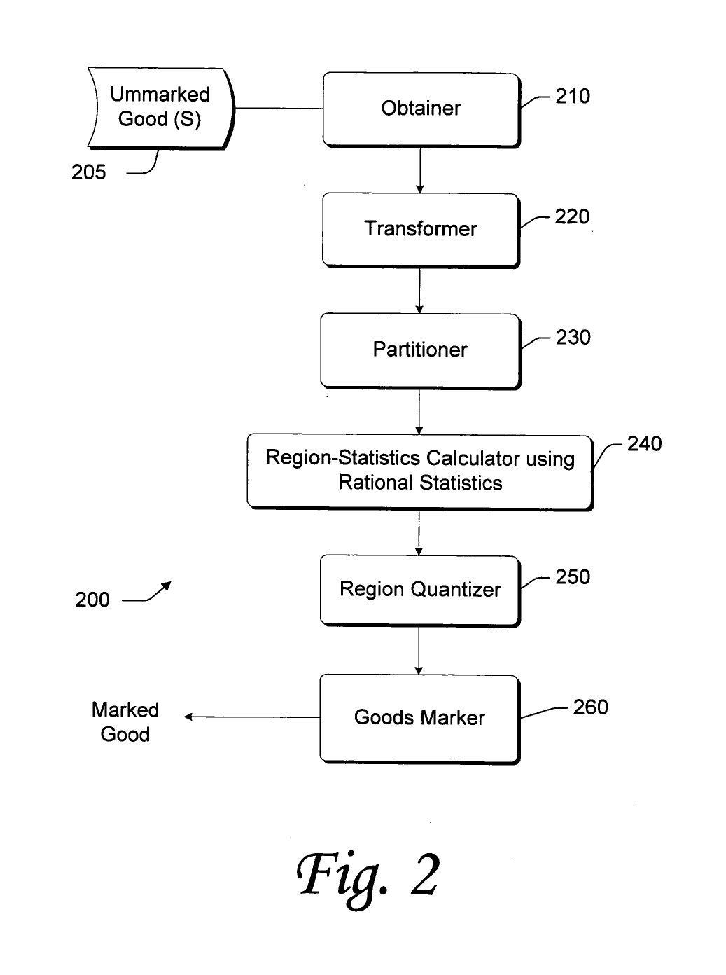

FIG. 2 shows an exemplary statistics quantization watermark embedding system 200. This system may be employed as the watermark encoding system 132 of FIG. 1.

The watermark embedding system 200 includes a goods obtainer 210, a transformer 220, a partitioner 230, a region-statistics calculator 240, a region quantizer 250, and a goods marker 260.

The watermark embedding system 200 embeds a watermark into a digital good. In this example, the digital good is an image. Thus, the system 200 embeds a watermark in the DC subband of a discrete wavelet transform (DWT) via subtractive dithered scalar quantization of statistics of randomly chosen regions. Of course, other statistics, subbands, and transforms may be employed. Furthermore, this technique can also be applied other digital media sources, such as audio (e.g., in the time-frequency domain) or video.

The goods obtainer 210 obtains a digital good 205 (such as an audio signal or a digital image). It may obtain the good from nearly any source, such as a storage device or over a network communications link. In addition to obtaining, the goods obtainer 210 may also normalize the amplitude of the good. In that case, it may also be called an amplitude normalizer.

The transformer 220 receives the good from the goods obtainer 210. The transformer 220 puts the good in canonical form using a set of transformations. Specifically, discrete wavelet transformation (DWT) may be employed (particularly, when the input is an image) since it compactly captures significant signal characteristics via time and frequency localization. Other transformations may also be used. For instance, shift-invariant and direction-selective “complex wavelets” and some other suitable over-complete wavelet representations (e.g., steerable pyramids, etc.) or even wavelet packets may be good candidates (particularly for images).

The transformer 220 also finds the DC subband of the initial transformation of the signal. This DC subband of the transformed signal is passed to the partitioner 230.

If, for example, the good is an image I, the transformer 220 may resize it to a fixed size via interpolation and decimation, apply DWT to resulting image, and obtain the DC subband, I_{DC}. Let N be the number of coefficients in I_{DC}. The transformer 220 reorders I_{DC} to get N×1 host data s.

The partitioner 230 separates the transformed good into multiple, pseudo-randomly sized, pseudo-randomly positioned regions (i.e., partitions). For example, if the good is an image, it might be partitioned into two-dimensional polygons (e.g., regions) of pseudo-random size and location. In another example, if the good is an audio signal, a two-dimensional representation (using frequency and time) of the audio signal might be separated into two-dimensional polygons (e.g., triangles) of pseudo-random size and location.

The exemplary watermarker allows the usage of regions whose shapes may be arbitrary; in fact, these regions in general can be (possibly) disconnected sets. Thus, we are not confined with the choice of polygons, the shapes could, for instance, be circles, other arbitrary shapes and combinations thereof.

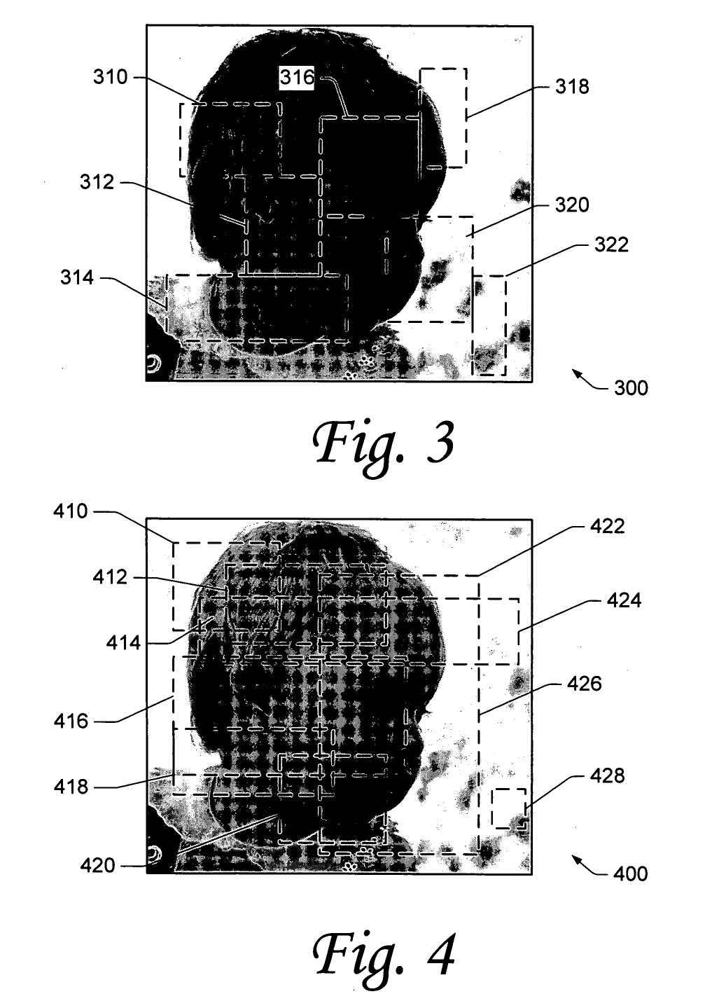

In some implementations, the partitioner 230 may restrict the regions so that they are not overlapping. FIG. 3 shows an example of an image with non-overlapping regions.

FIG. 3 illustrates an image 300 with multiple non-overlapping regions 310-322. In FIG. 3, the regions are rectangles. Note that none of the illustrated rectangles 310-320 cover common image area. The rectangles of FIG. 3 illustrate an example of a pseudo-random configuration of regions that are restrictively non-overlapping.

In at least one implementation, described herein, the partitioner 230 may indeed allow overlapping regions. FIG. 4 shows an example of an image with overlapping regions.

FIG. 4 illustrates an image 400 with multiple overlapping regions 410-428. In FIG. 4, the regions are rectangles. Note that many of the illustrated rectangles 410-426 cover common image areas. Some rectangles (such as 428) do not cover any common image areas and are not adjacent to any other rectangles. The rectangles of FIG. 4 illustrate an example of a pseudo-random configuration of regions that are permissively overlapping.

The exemplary watermarker avoids some of the limitations that were encountered in case of non-overlapping regions (e.g., the rate of the embedded watermark and the size and/or quantity of regions that are used in watermark embedding, the amount of distortion that is introduced by the watermark, etc.). It also avoids introduction of perceptible artifacts around the boundaries of the non-overlapped regions.

If, for example, the good is the above-referenced image I, the partitioner 230 pseudo-randomly generates sufficiently large M polygons (e.g., regions 310-322 and regions 410-428) represented by {Rᵢ}ᵢ₌₁^{M}. {Rᵢ}ᵢ₌₁^{M} together with corresponding pseudo-random weight vectors {aᵢ}ᵢ₌₁^{M},{aᵢ}ᵢ₌₁^{M}, thereby forming the corresponding pseudo-random transformation matrix T₁ of size M×N.

The partitioner 230 uses secret key K as the seed for its pseudo-random number generation. This same K may be used to reconstruct the regions by an exemplary statistics quantization watermark detecting system 500. Alternatively, a group of different secret keys may be used in the whole process; one of these keys may be used as the seed in one pseudorandom process whereas another key may be used as the seed in another pseudorandom process of the whole algorithm.

When randomization is mentioned herein, it should be understood that the randomization is carried out by means of a secure pseudo-random number generator (e.g., RC4) whose seed is a secret key. This key is typically shared between a watermark embedder and detector, but it is unknown to the adversary. (i.e., the scheme is anti-symmetric, private key in the crypto terminology).

For each region, the region-statistics calculator 240 calculates statistics of the multiple regions, which were generated by the partitioner 230. The pseudo-random statistics corresponding to each region (Rᵢ) is given by hᵢ, which is calculated based upon “rational statistics” formulation.

In particular, an implementation calculates hᵢ based upon a hashing function employing a quotient of weighted linear statistical functions using the input digital good (s) and Rᵢ. The weights used here are given by the vectors {aᵢ} and {bᵢ}, which may be pseudo-randomly chosen.

An example of a specific hashing function calculation given by Equation 1 below.

For each region, the region quantizer 250 applies a possibly high-dimensional (e.g., 2, 3, 4) quantization (e.g., lattice vector quantization) on the output of the region-statistics calculator 240 to obtain quantized data. For example, these statistics may be quantized using the length-M watermark vector w∈{0, 1}^{M}.

Of course, other levels of quantization may be employed. The quantizer 250 may be adaptive or non-adaptive. This is the part where data embedding takes place; in the quantization process, one chooses a particular quantizer that is indexed by the watermarking bit that one would like to embed.

This quantization may be done randomly also. This may be called randomized quantization (or randomized rounding). This means that the quantizer may pseudo-randomly decide to round up or round down. This adds an additional degree of robustness and helps hide the watermark.

Although at least one implementation, described herein, focuses on scalar uniform quantization, it may employ vector quantization. For example, lattice vector quantization may be used because it may be more tractable for high dimensional quantization in case of special lattices for which fast (possibly approximate) rounding algorithms can be derived.

The goods marker 260 marks the goods using quantization watermarking techniques. This marked good may be publicly distributed to consumers and clients.

This exemplary statistics quantization watermark embedding system 200 maps the change in the hash vector space to the data space of the subject digital goods. There is a dimensionality reduction from the goods' data space to the hash vector space. This exemplary statistics quantization watermark embedding system 200 is designed to minimize the perceptual distortion between the watermarked data and the data of the digital goods.

Rational Statistics

The pseudo-random statistics for a chosen region are based on “rational” statistics. More particularly, the rational statistics are based upon a quotient of two weighted linear statistical combinations. More particularly still, the rational statistics are based upon a hashing function employing a quotient of two weighted, linear, statistical combinations. An example of a specific hashing function employed by at least one implementation is given below by Equation 1.

Let s denote the host data (i.e., original digital good) of dimension N×1 into which watermark w is to be embedded, where w∈{0, 1}^{M}, ∀ᵢ. Watermark w is an M×1 vector, where M is the length of the watermark “message”. Within this notation, the rate of the watermark encoding is M/N.

In order to embed wᵢ, the exemplary watermarker considers a “randomly chosen” region Rᵢ, where Rᵢ⊂{1,2, . . . ,N} (i.e., Rᵢ is the set of indices of elements of s to which watermark is going to be embedded. Also, for each wᵢ, the exemplary watermarker introduces weight vectors, aᵢ and bᵢ, which may be pseudo-randomly chosen.

The watermark vector w is embedded to the random “rational” statistics vector, h, where

$${h}_{i} = \frac{{\sum }_{j ∈ {R}_{i}} {α}_{ij} {s}_{j}}{{\sum }_{j ∈ {R}_{i}} {b}_{ij} {s}_{j}} {h}_{i} = \frac{{\sum }_{j ∈ {R}_{i}} {α}_{ij} {s}_{j}}{{\sum }_{j ∈ {R}_{i}} {b}_{ij} {s}_{j}} \qquad ( 1 )$$

where aᵢⱼ is the j^{th} element of aᵢ and bᵢ is the j^{th} element of bᵢ, and hᵢ is the i^{th} element of h.

Herein, Equation 1, above, is called the “digital-goods hashing function.”

Since the regions are generated in a distributed fashion, the random “rational” statistics calculation will stay approximately invariant under any local magnitude-scaling of the digital good, as long as the underlying scaling field is smooth enough.

Semi-Global Characteristics

Many conventional quantization watermarking techniques rely upon local characteristics within a host signal (i.e., a digital good). To quantize, conventional quantization watermarking relies exclusively upon the values of “individual elements” of the host signal. When quantizing, only the local characteristics of an “individual element” are considered.

Modifications—from either an attack or unintentional noise—can change local characteristics of a signal quite dramatically without being perceptually significant (i.e., audible or visible).

Semi-global characteristics are representative of general characteristics of a group or collection of individual elements. Semi-global characteristics are representative of the perceptual content of the region as a whole.

The “rational” statistics, introduced above, are not local characteristics. Rather, the rational statistics of a region are an excellent example of semi-global characteristics.

Exemplary Quantization Watermark Detecting System

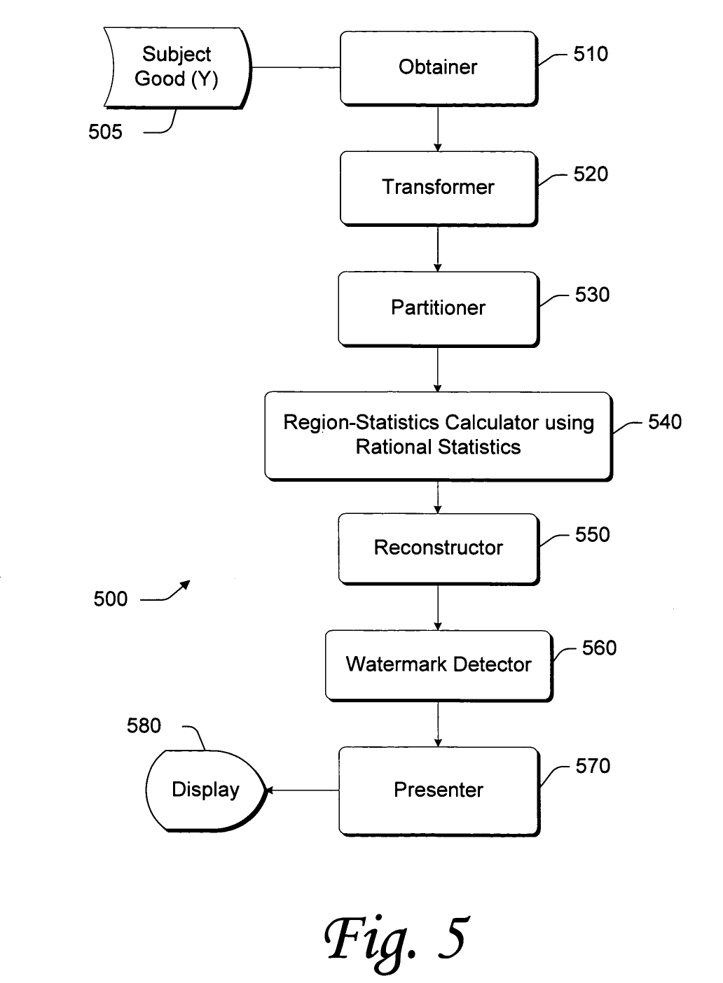

FIG. 5 shows an exemplary statistics quantization watermark detecting system 500, which is an example of an embodiment of a portion of the exemplary watermarker. This system may be employed as the watermark detecting system 152 of FIG. 1.

Upon the reception of the subject digital goods, the watermark detector first computes the hash values of the subject goods by using the same hashing function and the same secret key shared with the watermark embedder.

Based on the computation results of the hashing function, the detector makes the binary decision regarding as to whether or not the hash values come from the same watermarked goods which have been watermarked or not. Therefore, the watermark detection can be deemed as a decision process in the hash vector space instead of the goods space. This is desirable when the hash vector space takes into account the human perceptual mechanisms and uses explicit randomization.

The watermark detecting system 500 includes a goods obtainer 510, a transformer 520, a partitioner 530, a region-statistics calculator 540, a reconstructor 550, a watermark detector 560, a presenter 570, and a display 580.

The goods obtainer 510, the transformer 520, the partitioner 530, and the region-statistics calculator 540 of the watermark detecting system 500 of FIG. 5 function in a similar manner as similarly labeled components of the watermark embedding system 200 of FIG. 2. The exception is that the object of these components is a “subject good” (Y) rather than the original good (S). The origin of a “subject” good is an unknown. It may or may not include a watermark. It may have been modified.

Let μ_{y} be the statistics vector for the subject good Y. For each region i, let μ_{yi} be the i-th component of the statistics vector μ_{y}. The reconstructor 550 determines the closest reconstruction point that corresponds to quantizer 0 (quantizer 1), which is called μ_{yi}⁰(μ_{yi}¹), herein (i.e., performs nearest neighbor decoding).

The watermark detector 560 determines whether a watermark is present. It determines the log likelihood ratio:

$$L = {\sum }_{i = 1}^{M} {( - 1 )}^{{w}_{i} + 1} [ {( {μ}_{yi} - {μ}_{yi}^{1} )}^{2} - {( {μ}_{yi} - {μ}_{yi}^{0} )}^{2} ]$$

If L>τ, then the watermark detector 560 declares that the watermark is present; otherwise, declares that it is not present, where τ is some threshold and an input parameter to the process. Of course, there may be a range near the threshold where the determiner specifies that the watermark presence is indeterminate (e.g., if the likelihood L is close enough to threshold A, the detector may output “inconclusive” or “unknown” as a result).

The presenter 570 may present one of three indications: “watermark present,” “watermark not present,” and “unknown.” This information is presented on the display 580. Of course, this display may be any output device. It may also be a storage device.

The functions of aforementioned components of the exemplary statistics quantization watermark detecting system 500 of FIG. 5 are explained further below.

The exemplary statistics quantization watermark detecting system 500 may be either blind or semi-blind. In the blind scenario, the detector does not know the watermark itself in order to detect it in a signal.

In the semi-blind scenario, the detector does not know the watermark itself, but it does know some side information that was also embedded into the subject digital goods. From the detection point of view, the side information will not hurt detection, because such information can always be disregarded.

In fact, if the side information is chosen properly, it would improve the performance of the detector. Thus, appropriately-designed semi-blind schemes perform at least as good as blind schemes from a detection theoretic perspective. However, if the side information H is also accessible by the attacker, the attacker might potentially use this information to implement more effective attacks. This constitutes a trade-off in terms of the presence (or the amount) of the side information from a security point of view.

Therefore, semi-blind detection is most effective when such side information is either not accessible, or not “usable” by the attacker. Such an assumption holds for fingerprinting scenarios where the watermark acts as a “fingerprint” to identify an end-user, distributor, etc. of the goods. In such applications, the detector is not given to the public. Detection is carried out in a secure server where computational complexity requirements are relaxed.

Methodological Implementation Employing the Digital-Goods Hashing Function

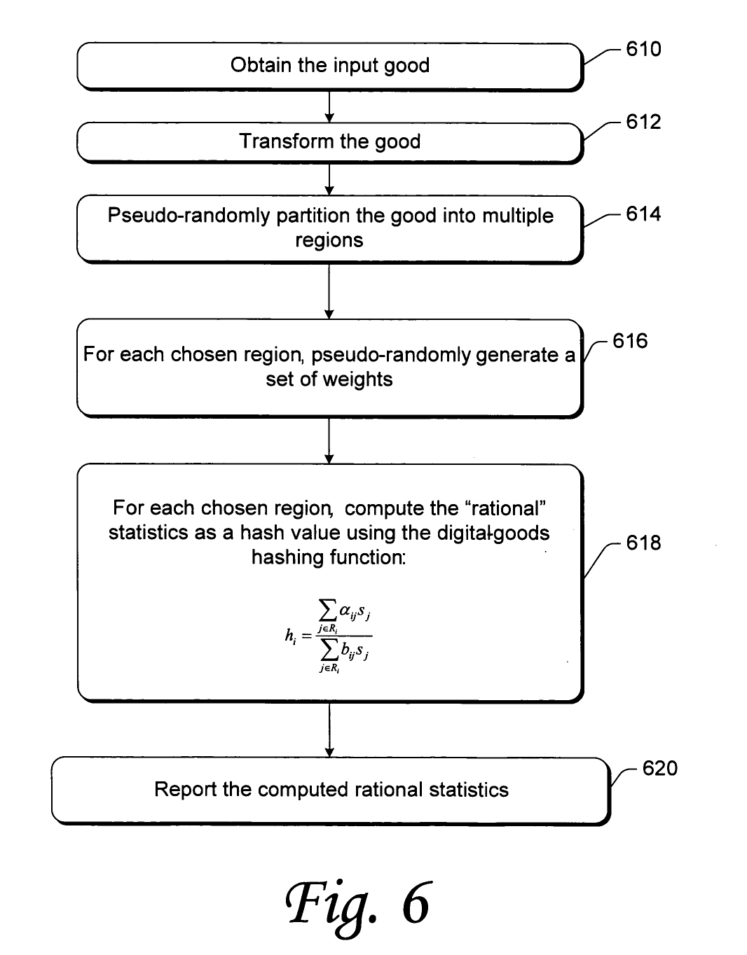

FIG. 6 shows a methodological implementation using the digital-goods hashing function (depicted above in Equation 1). This methodological implementation may be performed in software, hardware, or a combination thereof. For ease of understanding, the method steps are delineated as separate steps; however, these separately delineated steps should not be construed as necessarily order dependent in their performance.

This methodological implementation takes an input digital good s' and the cryptographic key k as its input and produces a hash vector h of the input digital good.

At 610 of FIG. 6, the exemplary watermarker obtains the input good, such as input good s′.

At 612, the exemplary watermarker perform a transformation on the input good. For example, the transformation may be a 3-level DWT on the input good and denotes the DC subband coefficient vector as s.

At 614, the exemplary watermarker uses the cryptographic key k to tilt the 3-level DC subband of the input good into regions Rᵢ, where i=1, 2, . . . , L. The position for each region is uniform over the whole DC subband. The region size is uniformly distributed in [α, β], where α and β are algorithmic parameters. As the number of regions increase, there is an increasing probability for these regions to overlap.

At 616: For each chosen region Rᵢ, the exemplary watermarker uses the cryptographic key k to generate a set of weights {aᵢⱼ} for each coefficient sⱼ∈Rᵢ. (aᵢⱼ=0 otherwise.) The weights are generated independently for different regions, overlapping or not.

The random weights play a role in the hashing function. These weights may be completely independent. From the security point of view, the independent weights have the maximum entropy given the mean and variance. In that case, for each given region, the weights {aᵢⱼ} are generated as independent

$$N ( \frac{1}{\vert {R}_{i} \vert} , \frac{{σ}^{2}}{{\vert {R}_{i} \vert}^{2}} )$$

random variables (i.e., Gaussian distribution), where a is an algorithmic parameter.

However, from a robustness point of view, independent weights may bring fragility against de-synchronization attacks when the digital goods are images. In the context of at least one implementation, the attack may aim at mismatching the weights and the DWT coefficients at the watermark detector.

In the image-processing literature, the DC subband of natural images has always been always modeled as a smoothly varying field using Markov or hidden Markov models. Therefore, correlated weights provide better resilient property against non-noticeable de-synchronization attacks, because they provide a better match with natural image spectra.

In practice, lpthe correlated weights are generated by passing the independent

$$N ( 0 , \frac{{σ}^{2}}{{\vert {R}_{i} \vert}^{2}} )$$

weights to an ideal two-dimensional low-pass filter. The cutoff frequency of the low-pass filter is a parameter which controls the security and robustness tradeoff of the watermarking scheme. It also turns out that the choice of the cutoff frequency affects the distortion level of the watermarked image, both in the mean-square-error (MSE) sense and in the perceptual sense. After low-pass filtered, the weights weight {aᵢⱼ} for each rectangle is normalized to have the same l₂ norm

$$\sqrt{\frac{1}{\vert {R}_{i} \vert}} .$$

At 618: For each chosen region Rᵢ, the exemplary watermarker computes the random “rational” statistics as a hash value using the digital-goods hashing function of the above Equation 1. That equation is reproduced here for ease of reading:

$${h}_{i} = \frac{{\sum }_{j ∈ {R}_{i}} {α}_{ij} {s}_{j}}{{\sum }_{j ∈ {R}_{i}} {b}_{ij} {s}_{j}}$$

where

$${b}_{ij} = \frac{1}{\vert {R}_{i} \vert}$$

if sⱼ∈Rᵢ and bᵢⱼ=0 otherwise, and |·| denotes the cardinality of a finite set.

At 620, the exemplary watermarker reports the computed hash values (which are the rational statistics). In the watermark embedder, this may be used to embed a watermark via designing a watermarking sequence such that the rational statistics of the watermarked signal are quantized versions of the rational statistics of the original image. In a watermark detector, this may be used to detect, extract, and/or verify a watermark.

The quantization of rational statistics may be carried out via solving a “minimum-norm” type optimization problem. The following reference provides an example of watermark quantization of statistics via solving a “minimum-norm” type optimization problem: U.S. Patent Application Publication No. 20040001605, entitled “Watermarking Via Quantization of Statistics of Overlapping Regions”, filed on Jun. 28, 2002 and published on Jan. 1, 2004.

Exemplary Computing System and Environment

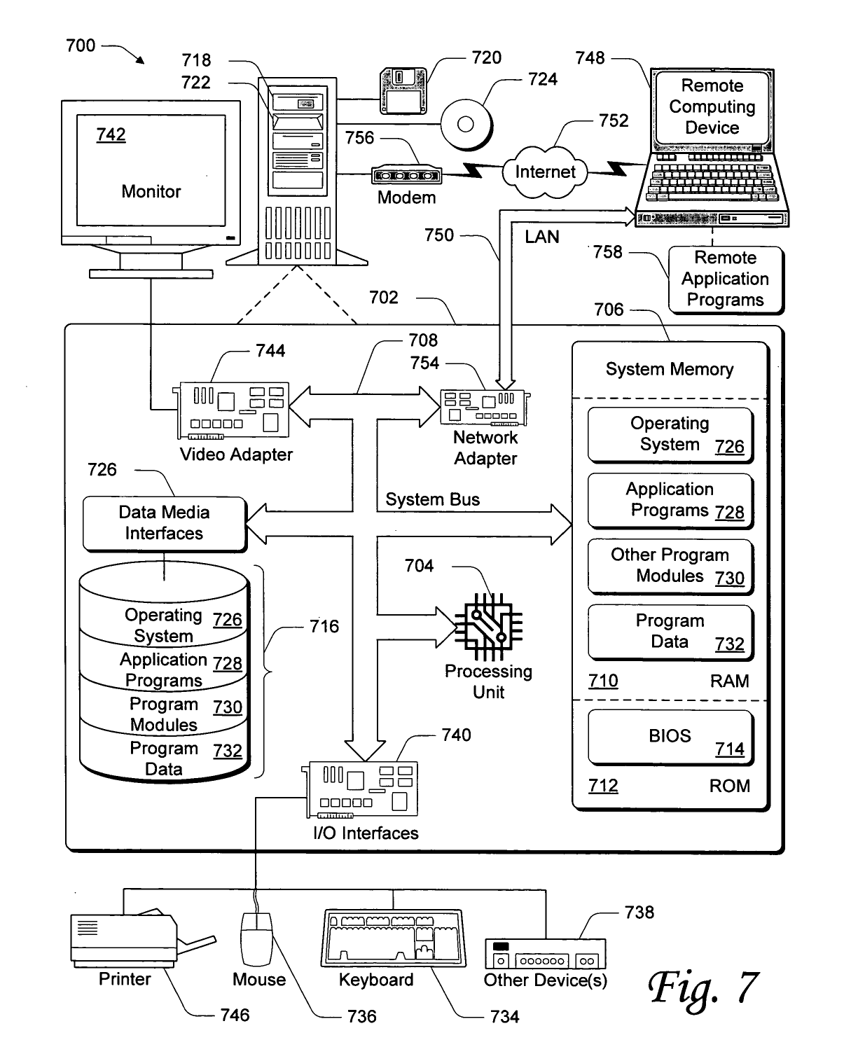

FIG. 7 illustrates an example of a suitable computing environment 700 within which an exemplary watermarker, as described herein, may be implemented (either fully or partially). The computing environment 700 may be utilized in the computer and network architectures described herein.

The exemplary computing environment 700 is only one example of a computing environment and is not intended to suggest any limitation as to the scope of use or functionality of the computer and network architectures. Neither should the computing environment 700 be interpreted as having any dependency or requirement relating to any one or combination of components illustrated in the exemplary computing environment 700.

The exemplary watermarker may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary watermarker may be described in the general context of processor-executable instructions, such as program modules, being executed by a computer. Generally, program modules include routines, programs, objects, components, data structures, etc. that perform particular tasks or implement particular abstract data types. The exemplary watermarker may also be practiced in distributed computing environments where tasks are performed by remote processing devices that are linked through a communications network. In a distributed computing environment, program modules may be located in both local and remote computer storage media including memory storage devices.

The computing environment 700 includes a general-purpose computing device in the form of a computer 702. The components of computer 702 may include, but are not limited to, one or more processors or processing units 704, a system memory 706, and a system bus 708 that couples various system components, including the processor 704, to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include a CardBus, Personal Computer Memory Card International Association (PCMCIA), Accelerated Graphics Port (AGP), Small Computer System Interface (SCSI), Universal Serial Bus (USB), IEEE 1394, a Video Electronics Standards Association (VESA) local bus, and a Peripheral Component Interconnects (PCI) bus also known as a Mezzanine bus.

Computer 702 typically includes a variety of processor-readable media. Such media may be any available media that is accessible by computer 702 and includes both volatile and non-volatile media, removable and non-removable media.

The system memory 706 includes processor-readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternatively, the hard disk drive 716, magnetic disk drive 718, and optical disk drive 722 may be connected to the system bus 708 by one or more interfaces (not shown).

The disk drives and their associated processor-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of processor-readable media, which may store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, may also be utilized to implement the exemplary computing system and environment.

Any number of program modules may be stored on the hard disk 716, magnetic disk 720, optical disk 724, ROM 712, and/or RAM 710, including by way of example, an operating system 726, one or more application programs 728, other program modules 730, and program data 732.

A user may enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 704 via input/output interfaces 740 that are coupled to the system bus 708, but may be connected by other interface and bus structures, such as a parallel port, game port, or a universal serial bus (USB).

A monitor 742 or other type of display device may also be connected to the system bus 708 via an interface, such as a video adapter 744. In addition to the monitor 742, other output peripheral devices may include components, such as speakers (not shown) and a printer 746, which may be connected to computer 702 via the input/output interfaces 740.

Computer 702 may operate in a networked environment using logical connections to one or more remote computers, such as a remote computing device 748. By way of example, the remote computing device 748 may be a personal computer, portable computer, a server, a router, a network computer, a peer device or other common network node, and the like. The remote computing device 748 is illustrated as a portable computer that may include many or all of the elements and features described herein, relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet. Such networking environments may be wired or wireless.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which may be internal or external to computer 702, may be connected to the system bus 708 via the input/output interfaces 740 or other appropriate mechanisms. It is to be appreciated that the illustrated network connections are exemplary and that other means of establishing communication link(s) between the computers 702 and 748 may be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components, such as the operating system, are illustrated herein as discrete blocks, although it is recognized that such programs and components reside at various times in different storage components of the computing device 702, and are executed by the data processor(s) of the computer.

Processor-Executable Instructions

An implementation of an exemplary watermarker may be described in the general context of processor-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 7 illustrates an example of a suitable operating environment 700 in which an exemplary watermarker may be implemented. Specifically, the exemplary watermarker(s) described herein may be implemented (wholly or in part) by any program modules 728-730 and/or operating system 726 in FIG. 7 or a portion thereof.

The operating environment is only an example of a suitable operating environment and is not intended to suggest any limitation as to the scope or use of functionality of the exemplary watermarker(s) described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Processor-Readable Media

An implementation of an exemplary watermarker may be stored on or transmitted across some form of processor-readable media. Processor-readable media may be any available media that may be accessed by a computer. By way of example, processor-readable media may comprise, but is not limited to, “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies processor-readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, communication media may comprise, but is not limited to, wired media such as a wired network or direct-wired connection, and wireless media such as acoustic, RF, infrared, and other wireless media. Combinations of any of the above are also included within the scope of processor-readable media.

### Conclusion

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A processor-readable medium having processor-executable instructions that, when executed by a processor, performs acts comprising:
obtaining a digital good;
partitioning the digital good into a plurality of regions;
calculating rational statistics of one or more the regions of the plurality, so that the statistics of a region are representative of the region;
quantizing the statistics;
marking the digital good with the quantized statistics of the plurality of the regions.

2. A medium as recited in claim 1, wherein the calculating comprises generating the rational statistics of one or more regions of the plurality via a hashing function.

3. A medium as recited in claim 1, wherein the calculating comprises generating the rational statistics of one or more regions of the plurality via a hashing function employing a quotient of at least two weighted linear combinations of statistics of the one or more regions of the plurality.

4. A medium as recited in claim 1, wherein the calculating comprises generating the rational statistics of one or more regions of the plurality via a hashing function, h, where
$${h}_{i} = \frac{{\sum }_{j ∈ {R}_{i}} {α}_{ij} {s}_{j}}{{\sum }_{j ∈ {R}_{i}} {b}_{ij} {s}_{j}}$$
where:
aᵢⱼ is the j^{th} element of aᵢ and aᵢ are a pseudo-random generated weight factors;
bᵢⱼ is the j^{th} element of bᵢ and bᵢ are a pseudo-random generated weight factors;
s denotes the digital good of dimension N×1;
Rᵢ are the plurality of regions, where Rᵢ⊂{1,2, . . . ,N}.

5. A medium as recited in claim 1, wherein the partitioning comprises segmenting the digital good into a plurality of overlapped regions.

6. A medium as recited in claim 1, wherein the marking comprises embedding a watermark via quantization.

7. A modulated signal generated by a medium as recited in claim 1.

8. A computer comprising one or more processor-readable media as recited in claim 1.

9. A processor-readable medium having processor-executable instructions that, when executed by a processor, performs acts comprising
obtaining a digital good; and
using quantization, watermarking the digital good with a watermark, wherein such quantization is based upon semi-global characteristics of regions of the digital good, wherein such semi-global characteristics are generated via a hashing function employing a quotient of at least two weighted linear combinations of statistics of the regions of the digital good.

10. A modulated signal generated by a medium as recited in claim 9.

11. A modulated signal generated in accordance with the following acts:
receiving input from a client computer by way of a communications network, the input providing a parameter indicative of a request for a modulated signal generated by a medium as recited in claim 9;
generating the modulated signal by the medium as recited in claim 9;
sending the modulated signal via the communications network.

12. A computer comprising one or more processor-readable media as recited in claim 9.

13. A system for facilitating the protection of digital goods, the system comprising:
a partitioner configured to segment a digital good into a plurality of regions;
a region-statistics calculator configured to calculate statistics of one or more of the plurality of regions, wherein the statistics of a region are representative of that region;
a region quantizer configured to quantize such statistics of a region;
a digital-goods marker configured to generate a marked good using the quantized statistics.

14. A system as recited in claim 13, wherein the region-statistics calculator is further configured to generate the rational statistics of one or more regions of the plurality via a hashing function.

15. A system as recited in claim 13, wherein the region-statistics calculator is further configured to generate the rational statistics of one or more regions of the plurality via a hashing function, employing a quotient of at least two weighted linear combinations of statistics of the one or more regions of the plurality.

16. A system as recited in claim 13, wherein the partitioner is further configured to segment a digital good into a plurality of overlapping regions.

17. A system as recited in claim 13, wherein the region-statistics calculator is further configured to generate the rational statistics of one or more regions of the plurality via a hashing function, h, where
$${h}_{i} = \frac{{\sum }_{j ∈ {R}_{i}} {α}_{ij} {s}_{j}}{{\sum }_{j ∈ {R}_{i}} {b}_{ij} {s}_{j}}$$
where:
aᵢⱼ is the j^{th} element of aᵢ and aᵢ are a pseudorandom generated weight factors;
bᵢⱼ is the j^{th} element of bᵢ and bᵢ are a pseudorandom generated weight factors;
s denotes the digital good of dimension N×1;
Rᵢ are the plurality of regions, where Rᵢ⊂{1,2, . . . ,N}.
